(19) United States
(12) Patent Application Publication
(10) Pub. No.: US 2014/0173496 A1
(43) Pub. Date: Jun. 19, 2014

(54) ELECTRONIC DEVICE AND METHOD FOR TRANSITION BETWEEN SEQUENTIAL DISPLAYED PAGES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: HAI-SHENG LI, Shenzhen (CN); CHIH-SAN CHIANG, New Taipei (TW); YU-DA XU, Shenzhen (CN); GANG TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/105,143

(22) Filed: Dec. 12, 2013

(30) Foreign Application Priority Data
Dec. 13, 2012 (CN) 2012105371297

(51) Int. Cl. G06F 3/0483

(52) U.S. Cl. CPC G06F 3/0483
USPC 715/776

(57) ABSTRACT

A method for transition between sequential pages displayed by an electronic device which runs a slideshow presentation application program such as Microsoft® PowerPoint. The method includes the steps as follows. Generate input signals from a user tracing a simple shape with his fingertip on the screen. Identify the traced shape. The type of transition display property which is associated with the predefined shape is acquired when the traced and identified shape is substantially similar to a predefined shape stored in the storage unit. The transition to next displayed page is displayed with the acquired type of display transition property. A related electronic device is also provided.

### BACKGROUND

1. Technical Field

The present disclosure relates to an electronic device and a method for transition between sequential pages displayed on the electronic device.

2. Description of Related Art

A popular slideshow presentation application program is PowerPoint. The types of display properties of one or more slideshows of a PowerPoint (PPT) electronic file are predefined by the PowerPoint application program. That is, the digital representation of text or images can be tailored according to a user's preferences. The display properties can provide dynamic effects for the displayed slides of the PPT file. In particular, when the slideshow proceeds from one slide to the next, the display of transition from the preceding slide to the next slide can have different desired dynamic effects. For example, the transition may occur by way of “vertical blinds,” or by way of “horizontal blinds.” However, during a given slideshow, when a next slide needs to be displayed and the user (presenter) wants to change the type of dynamic effect that occurs in the displayed transition to the next slide, the user must effect such change by complicated manual input. This is time-consuming and inconvenient.

Therefore, what is needed is an electronic device and a method for transition between sequential pages displayed on the electronic device without the limitations described above.

### BRIEF DESCRIPTION OF THE DRAWINGS

The emphasis is placed upon clearly illustrating the principles of the present disclosure. Moreover, in the drawings, like reference numerals designate corresponding parts or sections throughout the views.

FIG. 1 is a block diagram of an electronic device in accordance with an embodiment of the present invention.

FIG. 2 is a schematic diagram showing display of a shape of a track of a user's sliding touch operation on a touch screen of the electronic device of FIG. 1, in accordance with the embodiment.

FIG. 3 is a schematic diagram showing a shape of a track of a user's fingertip motion captured by a camera of the electronic device of FIG. 1, in accordance with the embodiment.

FIG. 4 is a flowchart of a method for transition between sequential pages displayed on an electronic device, such as the one of FIG. 1, in accordance with an embodiment of the present invention.

### DETAILED DESCRIPTION

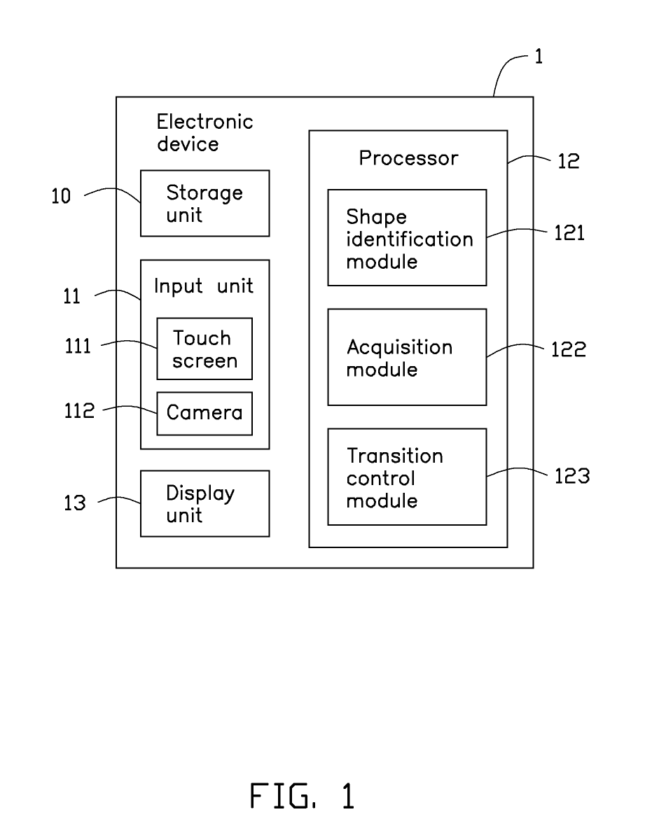

FIG. 1 is a block diagram of an electronic device 1. The electronic device 1 can run one or more presentation applications, such as PowerPoint of Microsoft® Corporation. A PowerPoint (PPT) electronic file can provide one or more slideshows for display on the electronic device 1. The electronic device 1 comprises an input unit 11. When displaying a slideshow, the electronic device 1 can change both the current slide being displayed and the type of dynamic effect displayed in the transition from the current slide to the next slide. For example, the transition may occur by way of “vertical blinds,” or by way of “horizontal blinds.” Each type of dynamic effect is predefined, and is referred to herein as a “predefined type of display transition property” or as a “display transition property.” The electronic device 1 effects both the change in the slide being displayed and a change in the type of display transition property by way of a shape drawn or traced on the input unit 11 by a user. The electronic device 1 identifies the shape and effects a corresponding change in the type of display transition property without any interruption to the slideshow. The electronic device 1 is typically a terminal device such as a personal computer or a tablet computer, for example.

The input unit 11 generates input signals in response to received user inputs. The input unit 11 is typically a touch screen, or a touchpad, or a camera, or another component or device which can detect and capture a shape traced by a user. In the embodiment, the input unit 11 comprises a touch screen 111 and a camera 112.

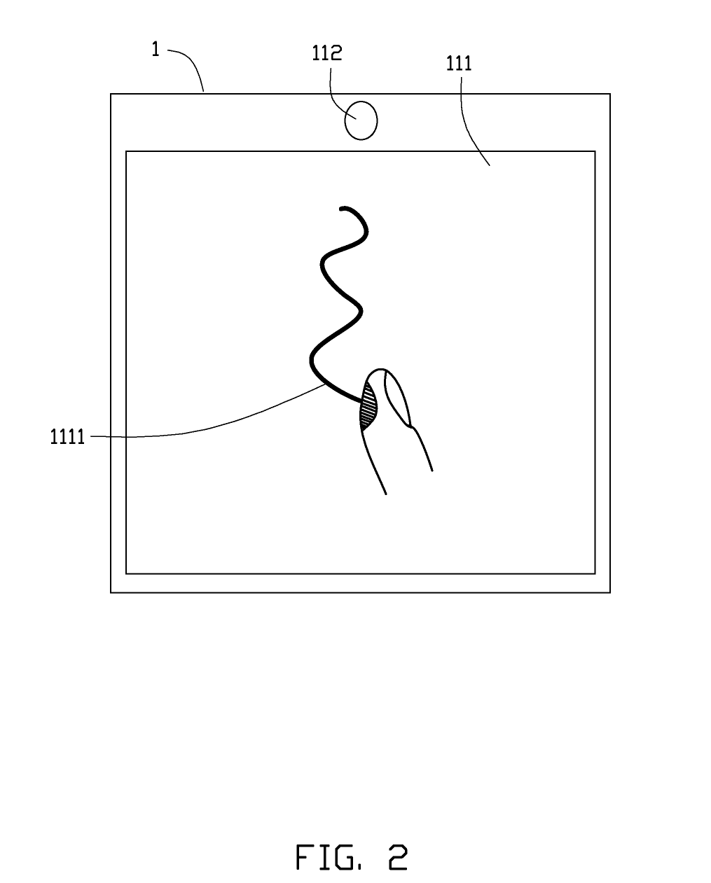

FIG. 2 shows a shape traced on the touch screen 111 of the electronic device 1. The touch screen 111 generates touch signals in response to a user's touch operation 1111 applied thereon.

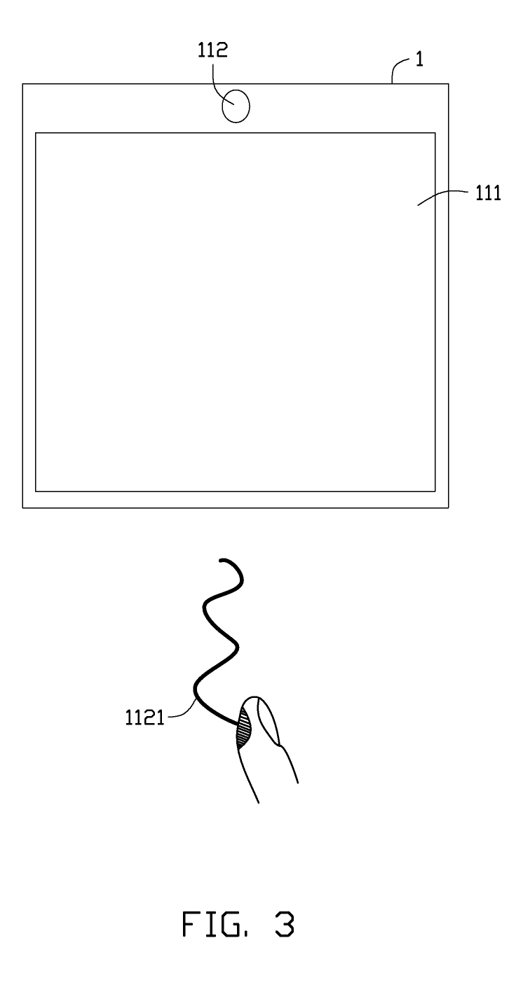

FIG. 3 shows a shape of a path of a user's moving fingertip, as captured by the camera 112 of the electronic device 1. The camera 112 captures a series of still pictures of a moving fingertip (or hand) of the user to obtain a movement track 1121, or records a video of the fingertip's movement track 1121, and then generates corresponding image signals. The captured series of pictures yielding the movement track 1121, or the video of the filmed fingertip's movement track 1121, are each stored by way of time vectors in a storage unit 10 of the electronic device 1.

The storage unit 10 also stores a number of slides containing still or moving content such as text, pictures, videos, and movies. The storage unit 10 further stores a number of predefined shapes, a number of types of display transition properties, and a mapping table recording a relationship between the predefined shapes and the types of display transition properties. In the mapping table, each type of display transition property is associated with a predefined shape or a number of predefined shapes. For example, a vertical snake shape is associated with a vertical blinds display transition property. In another example, the display transition property for vertical blinds can be associated with a number of shapes, such as a shape having a track of “□” (a square), a shape having a track of “Δ” (a triangle), and a shape having a track of “S.” The predefined shapes, the types of display transition properties, and the mapping table can all be default settings of the system of the electronic device 1, or can be predefined by a user of the electronic device 1.

The electronic device 1 further comprises a processor 12 and a display unit 13. The processor 12 comprises a shape identification module 121, an acquisition module 122, and a transition control module 123.

When the electronic device 1 is activated, a presentation application program such as PowerPoint is started, in order to play a slideshow. The change from the current slide and the type of display transition property that applies in the change to the next slide can both be effected by a shape traced by a user. The shape is detected by the touch screen 111, and/or the path of the shape traced by the user is captured by the camera 112.

The shape identification module 121 identifies the shape traced by the user according to touch signals received from the touch screen 111 or image signals received from the camera 112 without preference. For example, in one embodiment, the shape identification module 121 receives signals from both the touch screen 111 and the camera 112. In such case, the shape identification module 121 processes the touch signals from the touch screen 111 and the image signals from the camera 112 in the order in which the signals are received.

The shape identification module 121 further compares the identified shape with the predefined shapes stored in the storage unit 10, to determine whether the identified shape is substantially the same as one of the predefined shapes. The shape identification module 121 also transmits a determination (i.e. a result of the comparison) to the acquisition module 122.

The acquisition module 122 acquires a type of display transition property associated with the determined predefined shape from the storage unit 10, if the identified shape is substantially the same as one of the predefined shapes stored in the storage unit 10.

The transition control module 123 controls the display unit 13 to undergo transition to the next slide with the acquired type of display transition property. For example, if the default type of display transition property for the next slide is vertical blinds and the acquired type of display transition property is horizontal blinds, the transition control module 123 controls transition to the next slide with horizontal blinds.

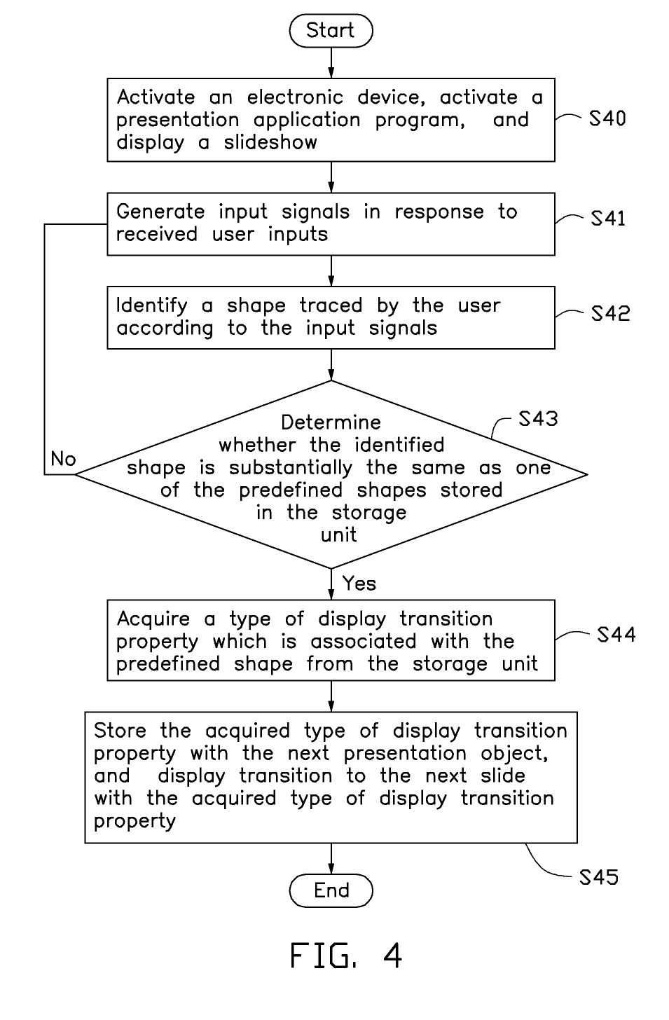

FIG. 4 is a flowchart of an exemplary method for transition between sequential pages displayed on an electronic device, such as the electronic device 1. The electronic device 1 comprises a storage unit 10 and an input unit 11. The storage unit 10 stores a number of predefined shapes, a number of types of display transition properties, and a mapping table recording a relationship between the predefined shapes and the types of display transition properties. The input unit 11 generates input signals in response to user operations. The method typically comprises the following steps, each of which is related to the various components contained in the electronic device 1.

In step S40, when the electronic device 1 is activated, a presentation application program is activated, and the display unit 13 displays a slideshow associated with the presentation application program.

In step S41, the input unit 11 generates input signals in response to received user inputs. In detail, the touch screen 111 generates touch signals in response to a user's touch operation 1111 thereon; and the camera 112 captures a series of pictures of the movement of the user's fingertip (or hand) to obtain a movement track 1121, or records a video of the fingertip's movement track 1121, and then generates corresponding image signals.

In step S42, the shape identification module 121 identifies the shape traced by the user according to the touch signals received from the touch screen 111 or the image signals received from the camera 112 without preference. In one example, the shape identification module 121 receives signals from both the touch screen 111 and the camera 112. In such case, the shape identification module 121 processes the touch signals from the touch screen 111 and the image signals from the camera 112 in the order in which the signals are received.

In step S43, the shape identification module 121 compares the identified shape with the predefined shapes stored in the storage unit 10, and determines whether the identified shape is substantially the same as one of the predefined shapes stored in the storage unit 10. If the determination is yes, the procedure goes to step S44; otherwise, the procedure goes back to step S41.

In step S44, the acquisition module 122 acquires a type of display transition property associated with the predefined shape from the storage unit 10.

In step S45, the transition control module 123 records the acquired type of display transition property, stores the acquired type of display transition property with the next presentation object (e.g. a slide), and controls the display unit 13 to undergo transition to the next slide with the acquired type of display transition property.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A method for transition between sequential pages displayed on an electronic device, the electronic device having an input unit and a storage unit, the storage unit having stored therein a mapping table recording a relationship between predefined shapes and types of display transition properties, the method comprising:
generating input signals in response to received user inputs;
identifying a shape traced by a user according to the input signals;
determining whether the identified shape is substantially the same as one of the predefined shapes stored in the storage unit;
acquiring a type of display transition property associated with the predefined shape when the identified shape is substantially the same as one of the predefined shapes stored in the storage unit; and
displaying transition to a next displayed page with the acquired type of display transition property.

2. The method as described in claim 1, wherein the input unit is one of a touch screen and a touchpad.

3. The method as described in claim 1, wherein generating input signals in response to received user inputs comprises one of:
generating image signals from capturing a series of pictures of a moving fingertip of the user by a camera; and
generating image signals from recording a video of a moving fingertip of the user by a camera.

4. An electronic device, comprising:
a storage unit, storing therein a plurality of predefined shapes, a plurality of types of display transition properties, and a mapping table recording a relationship between the predefined shapes and the types of display transition properties;
an input unit, configured for generating input signals in response to received user inputs;
a shape identification module, configured for identifying a shape traced by a user according to the input signals, and determining whether the identified shape is substantially the same as one of the predefined shapes stored in the storage unit;
an acquisition module, configured for acquiring a type of display transition property associated with the predefined shape when the identified shape is substantially the same as one of the predefined shapes stored in the storage unit; and
a transition control module, configured for controlling the electronic device to display transition to a next displayed page with the acquired type of display transition property.

5. The electronic device as described in claim 4, wherein the input unit is one of a touch screen and a camera.

6. The electronic device as described in claim 4, wherein the input unit is a camera, the input signals are image signals generated by the camera, and the image signals are generated from a series of captured pictures of a moving fingertip of the user or from a video recording of a moving fingertip of the user.

7. The electronic device as described in claim 6, wherein the shape identification module is configured for identifying the shape traced by the user according to the image signals generated by the camera.

8. The electronic device as described in claim 4, wherein in the mapping table, each type of display transition property is associated with a respective one of the predefined shapes or a respective plurality of the predefined shapes.
